(19) United States
(12) Patent Application Publication
(10) Pub. No.: US 2025/0309735 A1
(43) Pub. Date: Oct. 2, 2025

(54) SYSTEM AND METHOD FOR CONTROLLING A MACHINE FOR FORMING CONDUCTOR ELEMENTS OF AN INDUCTIVE WINDING OF A STATOR

(71) Applicant: ATOP S.P.A., Barberino Tavarnelle (IT)

(72) Inventors: Rubino CORBINELLI, Poggibonsi, Frazione Staggia Senese (IT); Anton Giulio ROGAI, Barberino Tavarnelle (IT); Emanuele ANGELINI, Buonconvento (IT)

(21) Appl. No.: 18/862,204

(22) PCT Filed: May 3, 2023
(86) PCT No.: PCT/IB2023/054605

§ 371 Date: Nov. 1, 2024

(30) Foreign Application Priority Data
May 3, 2022 (IT) 102022000008915

(51) Int. Cl. H02K 15/0421; G06T 7/00

(52) U.S. Cl. CPC H02K 15/0421; G06T 7/0004; G06T 2207/30136; G06T 2207/30164

(57) ABSTRACT

A system for controlling a machine for forming conductor elements of an inductive winding of a stator, which comprises:
a 3D vision device which is configured to generate a 3D reconstruction of each conductor element produced by the forming machine; and
a monitoring device which is operatively connected to the 3D vision device and operatively connectable to the forming machine;
where the monitoring device comprises:
   a measurement analysis module which is configured to assess at least one monitored characteristic measure of conductor elements that are produced by the forming machine; and
   a parameter correction module which is configured to correct one or more parameters of forming instructions that are executed by the forming machine.

The present invention relates to a system and a method for controlling the operations (bending, calendering, advancement and cutting) performed on an electric wire by a forming machine for the production of conductor elements or hairpins of an inductive winding of a stator.

The system and the method according to the present invention are particularly, although not exclusively, useful and practical in the area of controlling forming operations for the production of the conductor elements or hairpins that constitute the inductive windings of stators of electric machines, for example electric motors or electricity generators.

It is known that electric motors, dynamos, alternators and transformers comprise a core of ferromagnetic material on which windings are arranged which are made with electrical wires arranged according to a specific geometry. The circulation of an electric current in at least one of the windings determines, by electromagnetic induction, the circulation of an induced current in at least one other winding. Furthermore, between the ferromagnetic core and the respective windings, forces act on each other and are capable, for example, of turning a rotor with respect to a stator in an electric motor.

As mentioned, the inductive windings described above are made using wires of electrically conducting material, generally copper. For specific applications, inductive windings are made using wire-like elements of electrically conducting material, in short conductor elements, which are first inserted in specific slots which are provided in the ferromagnetic core of the electric machine under construction and then mutually stably coupled at at least one end, typically with welding operations.

A typical example of these conductor elements is the “hairpin”, where each one of the conductor elements is shaped like a fork. This fork has a pair of straight shanks which are mutually connected at one end by a bridge-like cross-piece. Typically the fork is shaped approximately like an upturned U with the bridge shaped like a cusp. Each shank of the fork, and therefore of the conductor element, has a free end for insertion in a respective slot of the ferromagnetic core of the electric machine. In particular, a first end of each conductor element is inserted into a respective first slot, while a second end of the same conductor element is inserted into a respective second slot, according to the desired logic for the inductive winding of the electric machine.

These conductor elements or hairpins are produced by forming machines which are adapted to perform operations to bend, calender, advance and cut a wire of electrically conducting material, generally copper. The operations performed by these forming machines are governed by forming instructions which comprise parameters that make it possible to obtain conductor elements or hairpins that have the necessary structural characteristics (for example shape, dimension, etc.) for the use for which they are intended.

This processing of the electric wire according to the forming instructions requires very precise operations, because the conductor elements or hairpins must be formed to comply with a very fine tolerance window.

In general, in mechanical technology, the term “tolerance” indicates a permitted deviation in the industrial manufacture of a part, in this case a conductor element or hairpin, between the ideal reference measurements, defined by the design drawings, and the effective measurements of the part produced; more precisely, a tolerance window is defined as the difference, or the range, between the maximum and minimum allowable measurements.

However, during the forming of the conductor elements or hairpins, external interference conditions and/or working conditions may arise that generate drifts that lead to the production of conductor elements or hairpins that fall increasingly outside this tolerance window and which therefore must be discarded or at least reworked. For example, external interference conditions can include variations in the hardness of the material used, and variations in the ambient temperature. For example, working conditions can include the play inside the forming machine, and variations in friction inside the forming machine.

Currently, human operators are employed to judge, periodically and on a spot-check basis, the quality of the forming operations, and as a consequence the quality of the conductor elements or hairpins of an inductive winding of a stator, using appropriate devices for magnification (for example a digital microscope) and/or for measurement. To simplify, a conductor element or hairpin can be considered good quality if the measurements that characterize it fall within the tolerance window described above with respect to corresponding master or reference characteristic measures, which obviously depend on the specific type of conductor elements or hairpins in production.

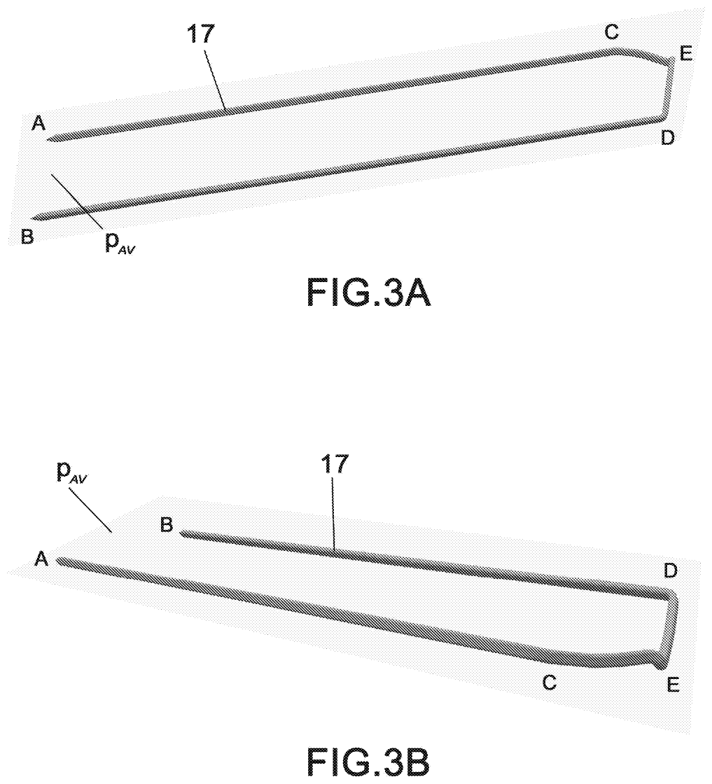

With reference to FIGS. 3A and 3B, any conductor element or hairpin 17 can be characterized by a set of five points, A, B, C, D and E. Using these five points, various characteristic measures of the conductor element or hairpin 17 can be obtained.

Therefore, the objective of the quality checks performed by human operators is to verify that the measurements that characterize the conductor elements or hairpins fall within the tolerance window for the corresponding reference characteristic measures, and that therefore those conductor elements or hairpins have the necessary structural characteristics for the use for which they are intended.

If these quality checks give a negative result, the human operators will act on the parameters of the forming instructions so as to recalibrate the forming machine, adapt the operations performed by the forming machine to the external interference conditions and to the working conditions, and so return to obtaining conductor elements or hairpins that have the necessary structural characteristics for the use for which they are intended.

However, this conventional methodology is not devoid of drawbacks, among which is the fact that the quality checks and any correction of the parameters of the forming instructions depend closely on the capabilities and/or conditions of the human operators who carry them out. In practice, the same human operator acts in a subjective manner and, therefore, can make different decisions in different contexts, on different days, etc.

Another drawback of this conventional methodology consists in that it entails very long reaction times, which lead to the production of great quantities of conductor elements or hairpins that must be rejected even if the quality checks give a negative result.

In particular, these reaction times depend both on the time that elapses between the first hairpin produced with characteristic measures outside of the tolerance window and the negative result of the quality checks, and also on the time that elapses between the negative result of the quality checks and the correction of the parameters of the forming instructions.

A further drawback of this conventional methodology consists in that it leads to an (albeit minimal) instability of the forming process, in particular of the operations performed by the forming machine.

Alternatively, it is possible to provide the forming machine with a device capable of detecting measurements that characterize the conductor elements or hairpins produced or being produced.

For example, German patent application no. DE102017207612A1 teaches the use of a digital camera to acquire in real time the geometry of the conductor element or hairpin being produced, while the conductor element or hairpin is being produced by a machine for forming metallic elements. In particular, the digital camera is oriented to acquire, with a rectangular field of view, both the conductor element or hairpin being produced and the bending tool of the forming machine, for the purpose of checking the forming process, in particular the bending angle of the conductor element or hairpin being produced.

Also for example, German patent application no. DE102019124477A1 teaches to use a 3D scanning device to detect one or more geometric characteristics of a conductor element or hairpin, for the purpose of correcting the forming parameters during the process of forming a conductor element or hairpin.

The aim of the present invention is to overcome the limitations of the known art described above, by devising a system and a method for controlling a machine for forming conductor elements or hairpins of an inductive winding of a stator that makes it possible to obtain better effects than those that can be obtained with conventional solutions and/or similar effects at lower cost and with higher performance levels.

Within this aim, an object of the present invention is to conceive a system and a method for controlling a machine for forming conductor elements or hairpins of an inductive winding of a stator that make it possible to adapt the operation of the forming machine, i.e. the operations performed by the forming machine, to the external interference conditions, such as for example variations in the hardness of the material used and variations in the ambient temperature.

Another object of the present invention is to devise a system and a method for controlling a machine for forming conductor elements or hairpins of an inductive winding of a stator that make it possible to adapt the operation of the forming machine, i.e. the operations performed by the forming machine, to the working conditions, such as for example the play inside the forming machine, and variations in friction inside the forming machine.

Another object of the present invention is to conceive a system and a method for controlling a machine for forming conductor elements or hairpins of an inductive winding of a stator that make it possible to make the forming process, in particular the operations performed by the forming machine, independent of the capabilities and/or conditions of human operators, so passing from a subjective checking to an objective and standardized checking, which leads to predictable and repeatable results.

Another object of the present invention is to devise a system and a method for controlling a machine for forming conductor elements or hairpins of an inductive winding of a stator that make it possible to eliminate, or at least minimize, the reaction times after the first hairpin produced with characteristic measures outside the tolerance window.

Another object of the present invention is to devise a system and a method for controlling a machine for forming conductor elements or hairpins of an inductive winding of a stator that make it possible to confer greater stability to the forming process, in particular to the operations performed by the forming machine.

Another object of the present invention is to provide a system and a method for controlling a machine for forming conductor elements or hairpins of an inductive winding of a stator that are highly reliable, easily and practically implemented, and economically competitive when compared to the known art.

This aim and these and other objects which will become more apparent hereinafter are achieved by a system for controlling a machine for forming conductor elements of an inductive winding of a stator, that comprises:
a 3D vision device which is configured to generate a 3D reconstruction of each conductor element produced by said forming machine; and
a monitoring device which is operatively connected to said 3D vision device and operatively connectable to said forming machine;
where said monitoring device comprises:
   a measurement analysis module which is configured to assess at least one monitored characteristic measure of conductor elements that are produced by said forming machine; and
   a parameter correction module which is configured to correct one or more parameters of forming instructions that are executed by said forming machine;
characterized in that
said measurement analysis module of said monitoring device is further configured to assess a trend of said at least one characteristic measure of a sequence of said conductor elements produced by said forming machine, said at least one monitored characteristic measure being obtained from said 3D reconstruction of said conductor element, and
said parameter correction module of said monitoring device is further configured to correct said parameters of forming instructions when said trend assessed by said measurement analysis module strays outwards from a tolerance window defined with respect to a respective reference characteristic measure, so as to prevent said trend from exiting said tolerance window.

The aim and objects are also achieved by a method for controlling a machine for forming conductor elements of an inductive winding of a stator, using a 3D vision device and a monitoring device, said 3D vision device being associable with said forming machine, said monitoring device being operatively connected to said 3D vision device and operatively connectable to said forming machine, which comprises the steps of:
generating a 3D reconstruction of each conductor element produced by said forming machine, using said 3D vision device;
extracting at least one characteristic measure of said conductor element from said 3D reconstruction of said conductor element produced by said forming machine;
assessing said at least one characteristic measure of conductor elements produced by said forming machine, using a measurement analysis module which is comprised within said monitoring device; and
correcting one or more parameters of forming instructions executed by said forming machine, using a parameter correction module which is comprised within said monitoring device;
characterized in that
said step of assessing further comprises the assessment of a trend of said at least one characteristic measure of a sequence of said conductor elements produced by said forming machine, and
said step of correcting said parameters of forming instructions occurs when said trend strays outwards from a tolerance window defined with respect to a respective reference characteristic measure, so as to prevent said trend from exiting said tolerance window.

Further characteristics and advantages of the present invention will become more apparent from the description of a preferred, but not exclusive, embodiment of the system and of the method for controlling a machine for forming conductor elements or hairpins of an inductive winding of a stator according to the invention, which is illustrated by way of non-limiting example with the aid of the accompanying drawings wherein:

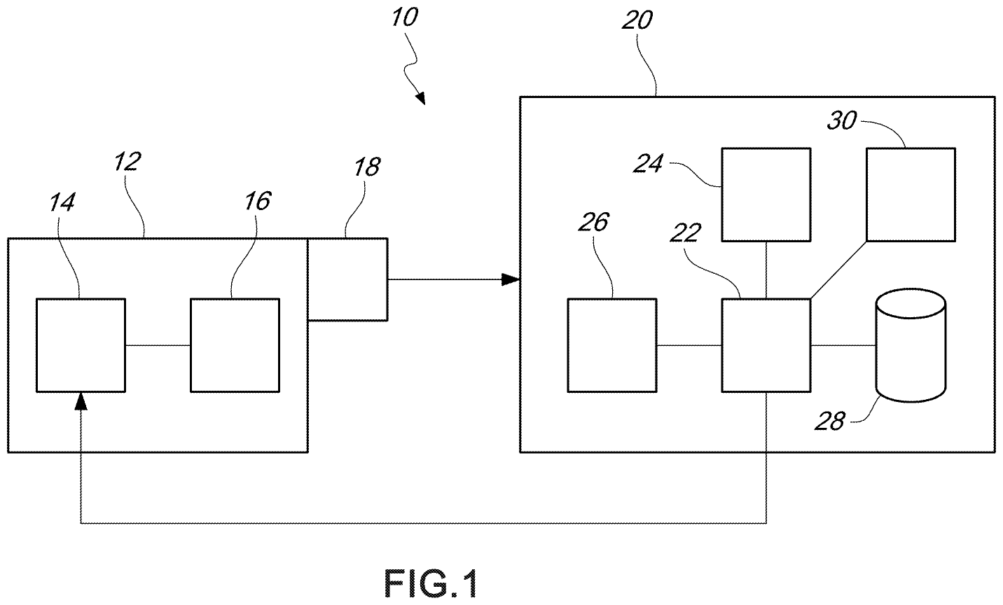

FIG. 1 is a schematic block diagram of an embodiment of the system for controlling a machine for forming conductor elements or hairpins of an inductive winding of a stator according to the present invention;

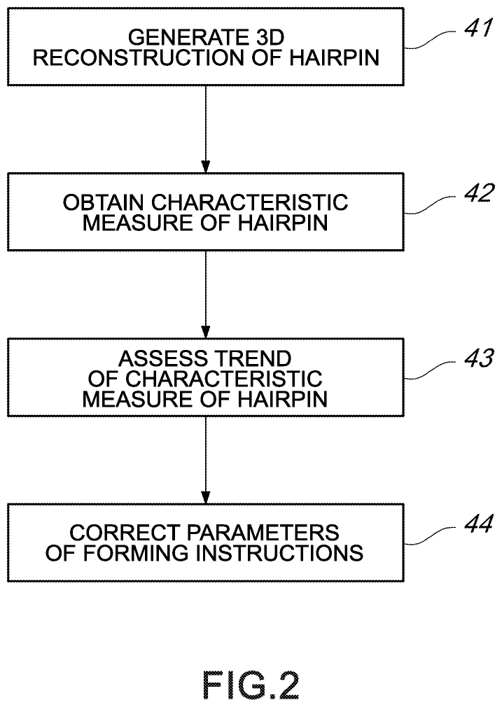

FIG. 2 is a schematic flowchart of an embodiment of the method for controlling a machine for forming conductor elements or hairpins of an inductive winding of a stator according to the present invention;

FIGS. 3A and 3B are perspective views of an example of a conductor element or hairpin of an inductive winding of a stator;

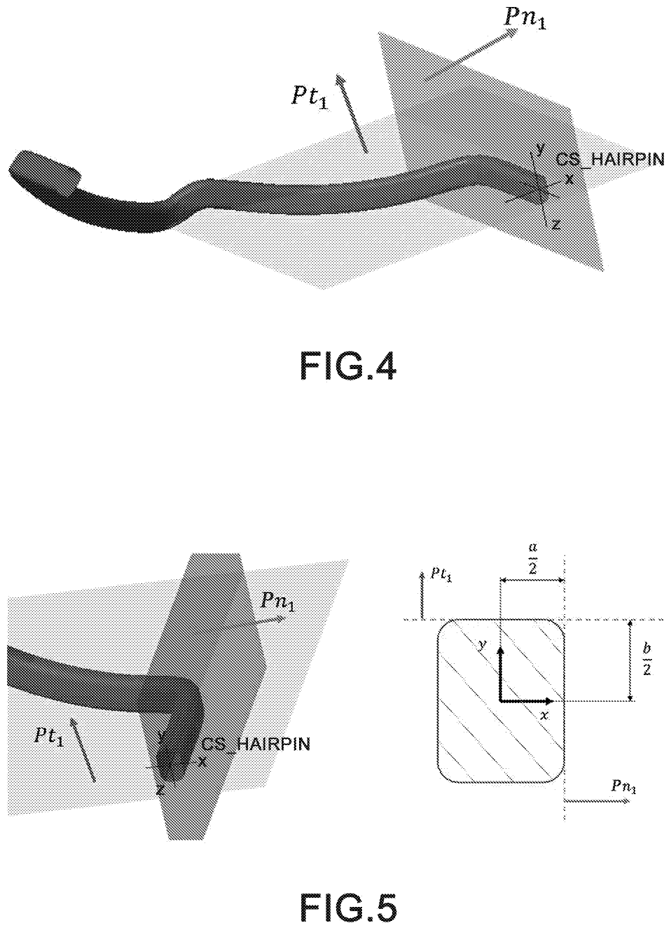

FIGS. 4 and 5 show a portion of a conductor element or hairpin of an inductive winding of a stator with indication of related measurements, in particular a first twisting plane Pₜ₁ and a first perpendicular plane Pₙ₁;

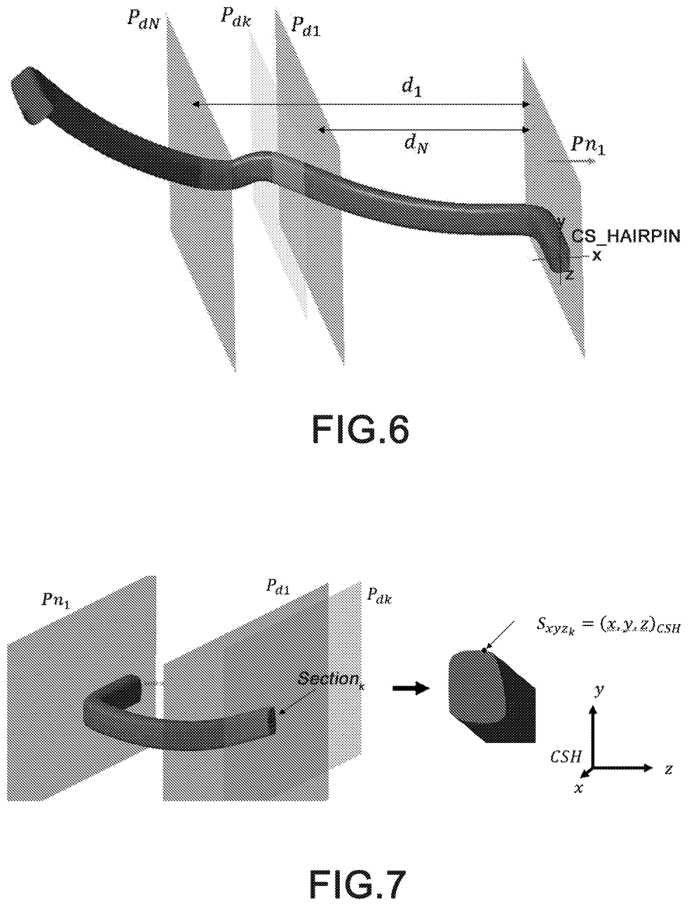

FIGS. 6 and 7 show a portion of a conductor element or hairpin of an inductive winding of a stator with indication of related measurements, in particular a central bending profile S_{XYZ};

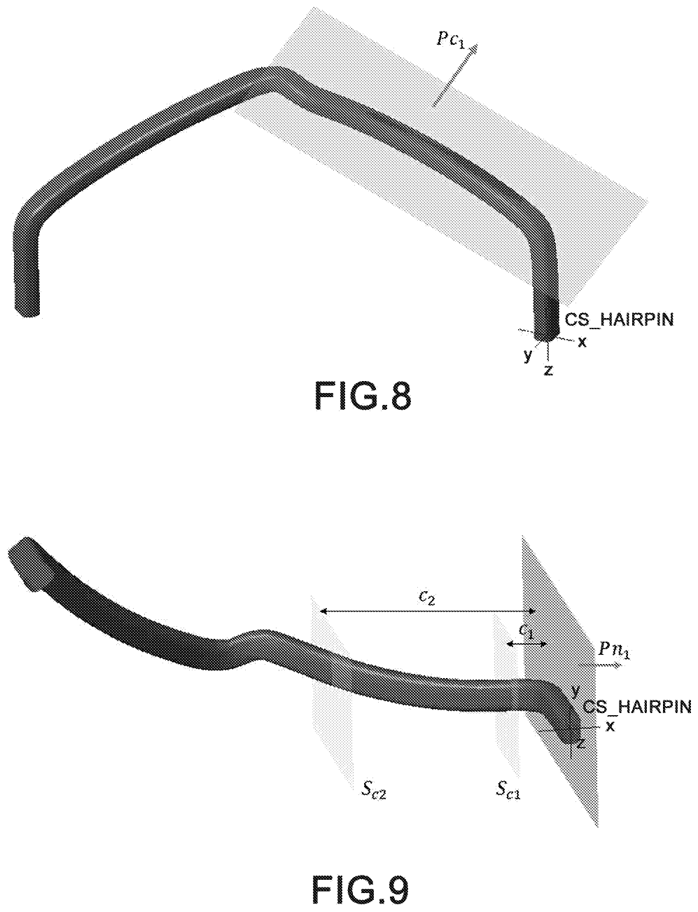

FIG. 8 shows a portion of a conductor element or hairpin of an inductive winding of a stator with indication of related measurements, in particular a first calendering plane P_{c1};

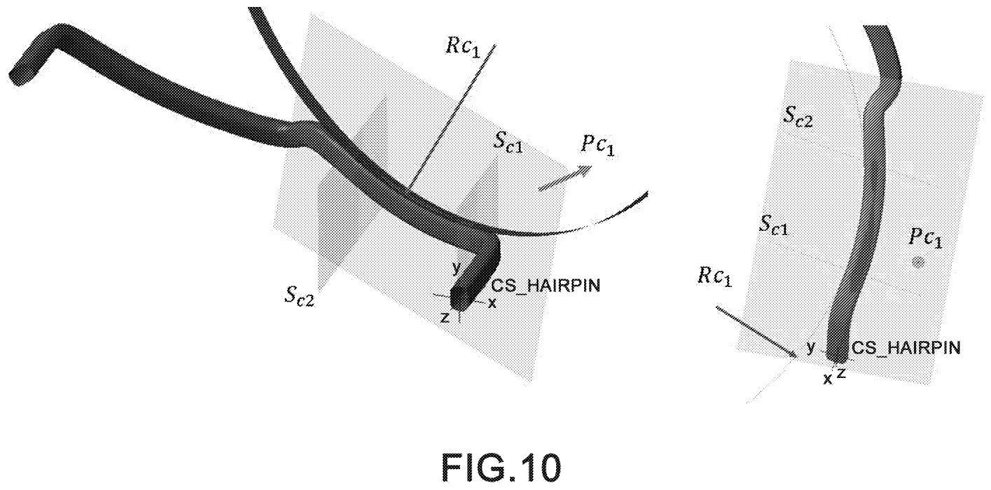

FIGS. 9 and 10 show a portion of a conductor element or hairpin of an inductive winding of a stator with indication of related measurements, in particular a first calendering radius R_{c1};

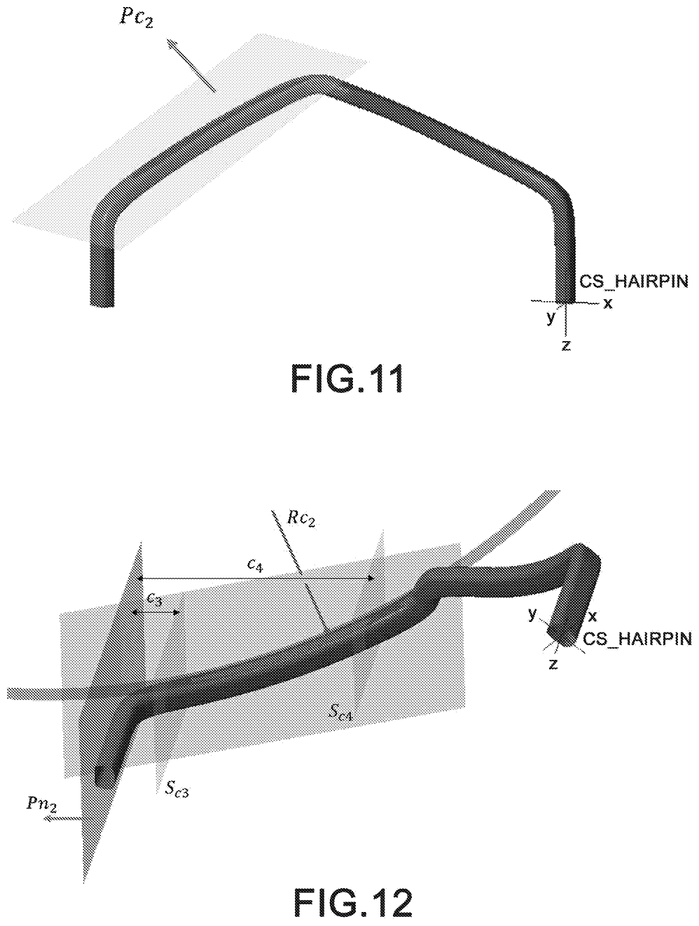

FIG. 11 shows a portion of a conductor element or hairpin of an inductive winding of a stator with indication of related measurements, in particular a second calendering plane P_{c2};

FIG. 12 shows a portion of a conductor element or hairpin of an inductive winding of a stator with indication of related measurements, in particular a second calendering radius R_{c2};

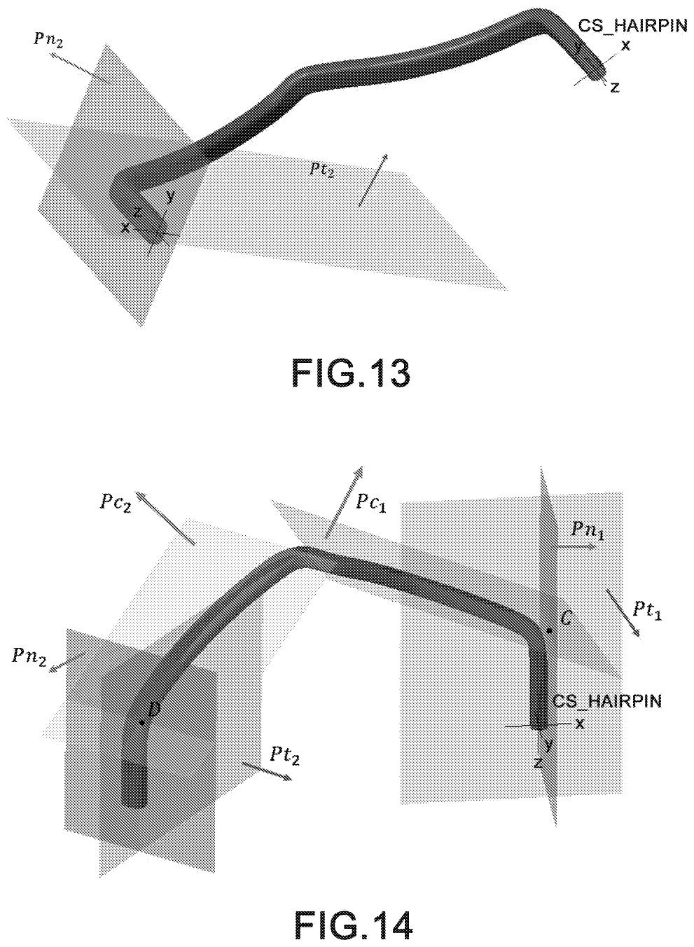

FIG. 13 shows a portion of a conductor element or hairpin of an inductive winding of a stator with indication of related measurements, in particular a second twisting plane Pₜ₂ and a second perpendicular plane Pₙ₂;

FIG. 14 shows a portion of a conductor element or hairpin of an inductive winding of a stator with indication of related measurements, in particular a first bending point C and a second bending point D;

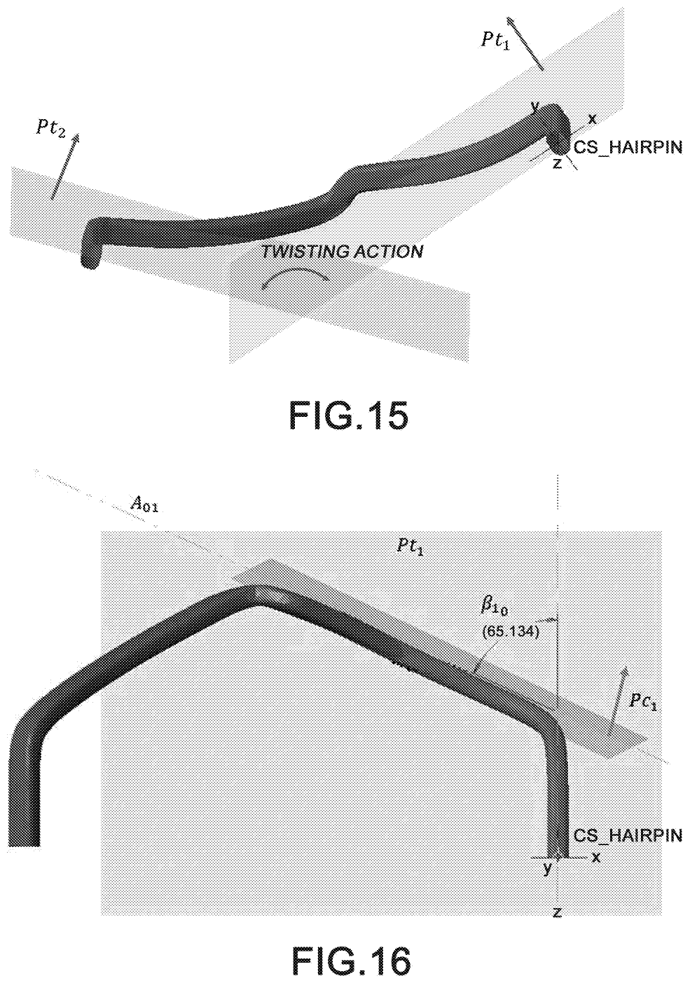

FIG. 15 shows a portion of a conductor element or hairpin of an inductive winding of a stator with indication of related measurements, in particular an angle between twists αₜ;

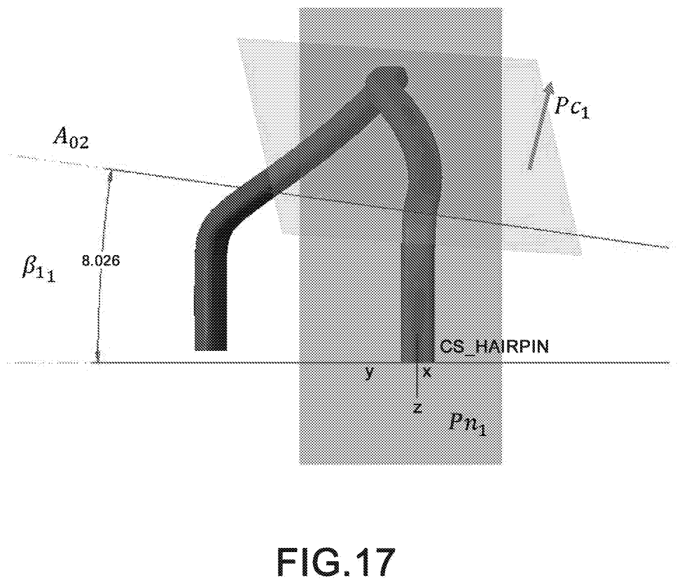

FIGS. 16 and 17 show a portion of a conductor element or hairpin of an inductive winding of a stator with indication of related measurements, in particular a first bending angle β₁;

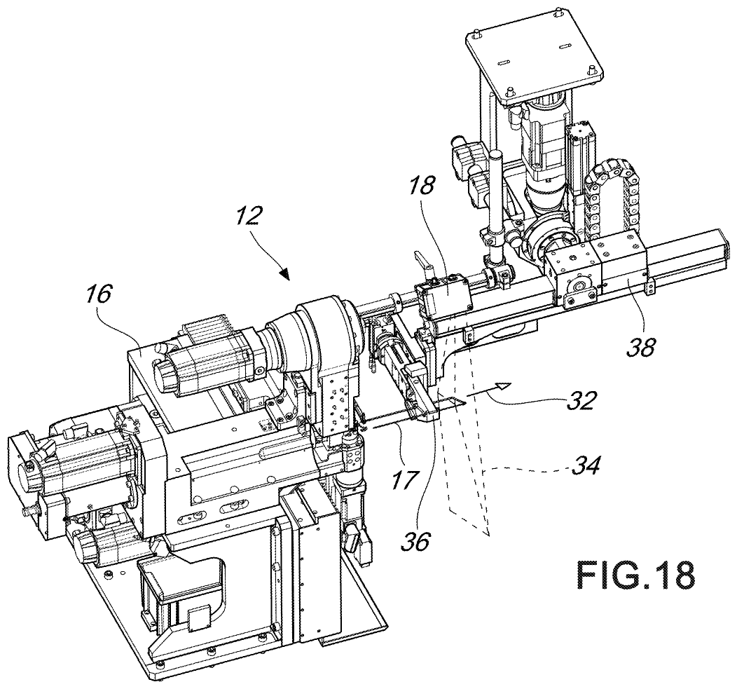

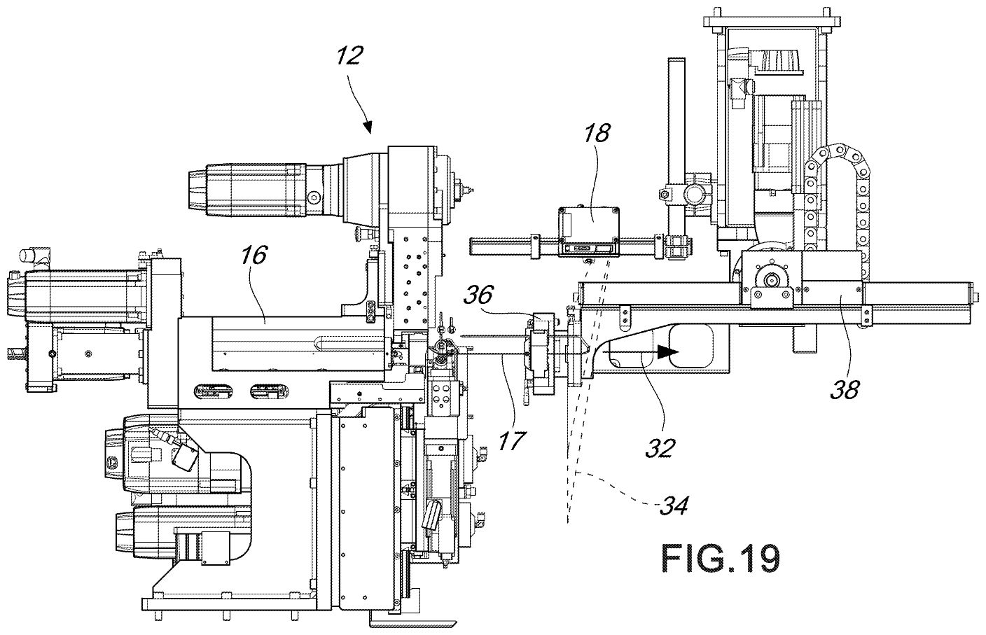

FIGS. 18 and 19 are respectively a perspective view and a side view of an embodiment of the forming machine, the three-dimensional vision device and the gripping element used to move the conductor element or hairpin away from the forming machine following the operations of bending, calendering, advancement and cutting;

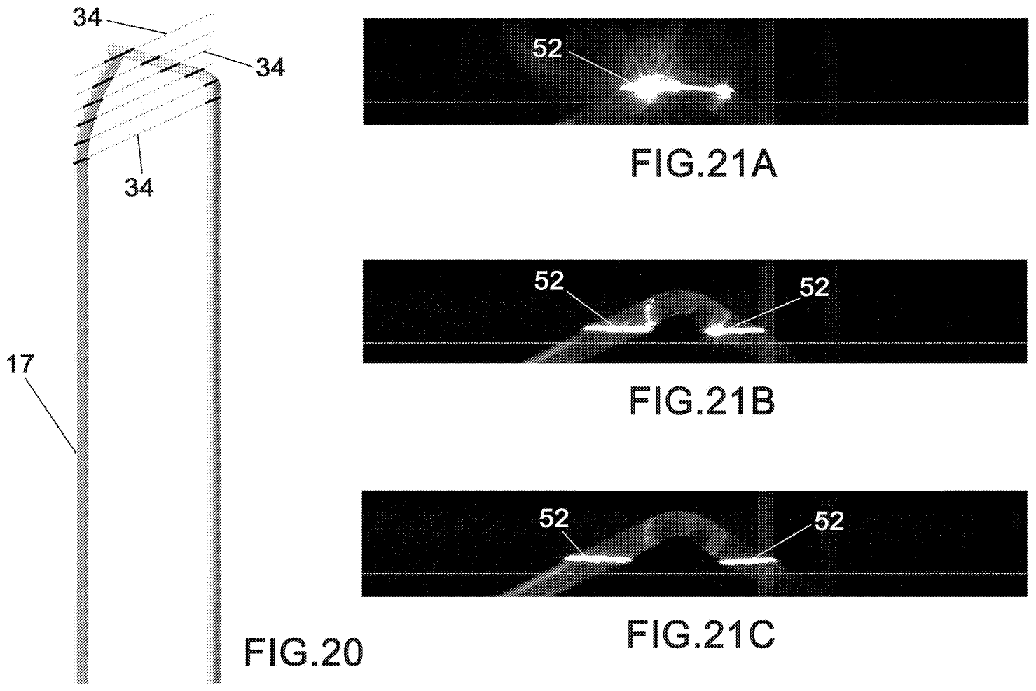

FIG. 20 shows a plurality of projections of the laser beam of the three-dimensional vision device on the conductor element or hairpin, these projections being used in order to obtain partial images of the conductor element or hairpin from which to obtain a three-dimensional reconstruction of the conductor element or hairpin;

FIGS. 21A, 21B and 21C show respective partial images of the conductor element or hairpin obtained from the three-dimensional vision device;

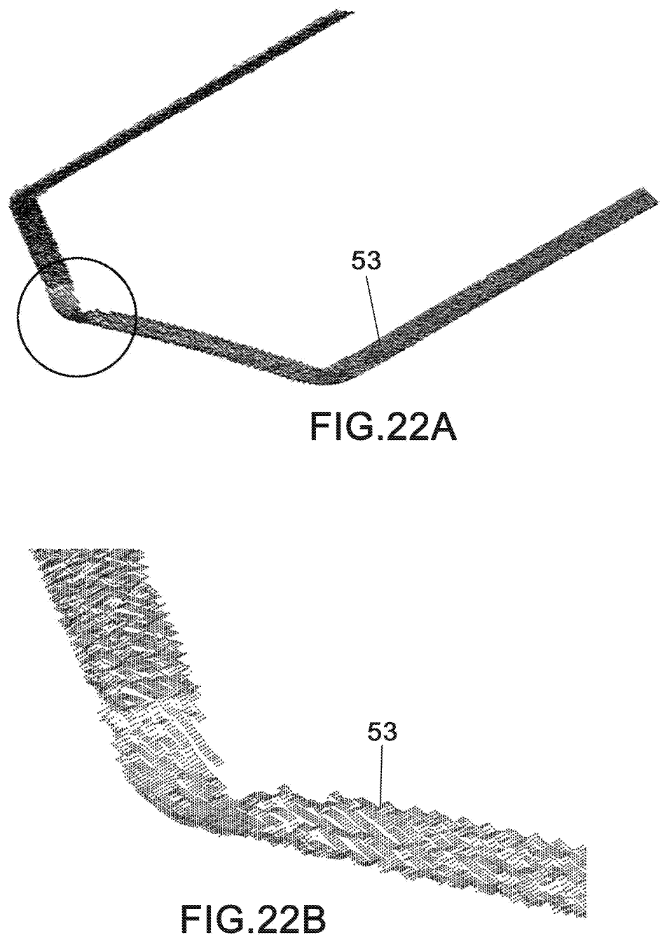

FIGS. 22A and 22B show respectively a point cloud and a detail of the point cloud, obtained from a concatenation of partial images of the conductor element or hairpin;

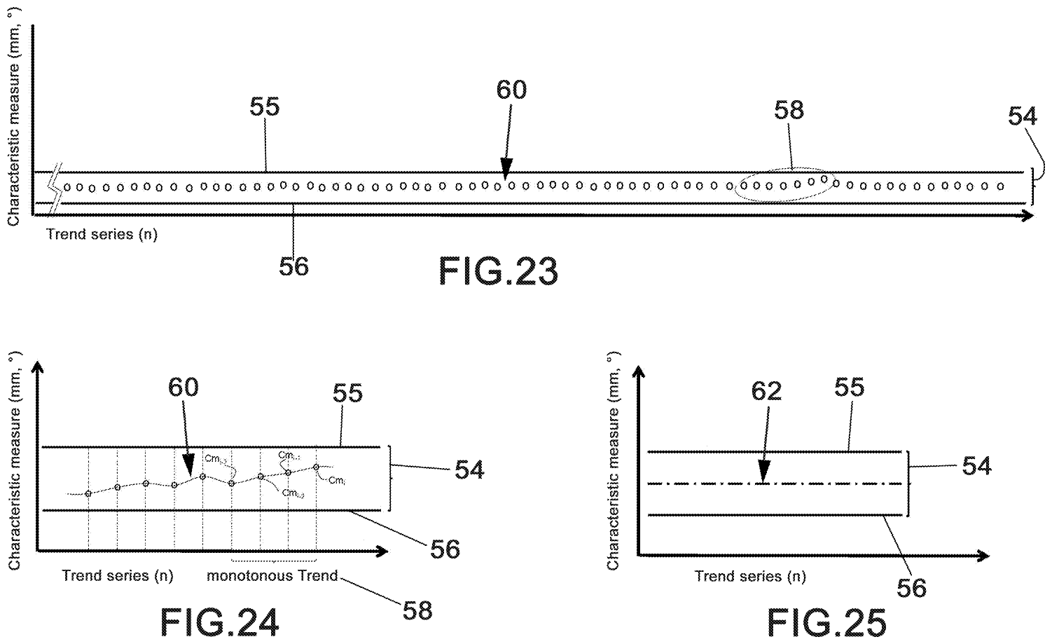

FIG. 23 shows a series of values of a characteristic measure, the relevant tolerance window constituted by an upper tolerance threshold and a lower tolerance threshold, and a trend of the values of the characteristic measure;

FIG. 24 shows a monotonous trend of a series of values of a characteristic measure;

FIG. 25 shows a master or reference characteristic measure and the relevant tolerance window constituted by an upper tolerance threshold and a lower tolerance threshold;

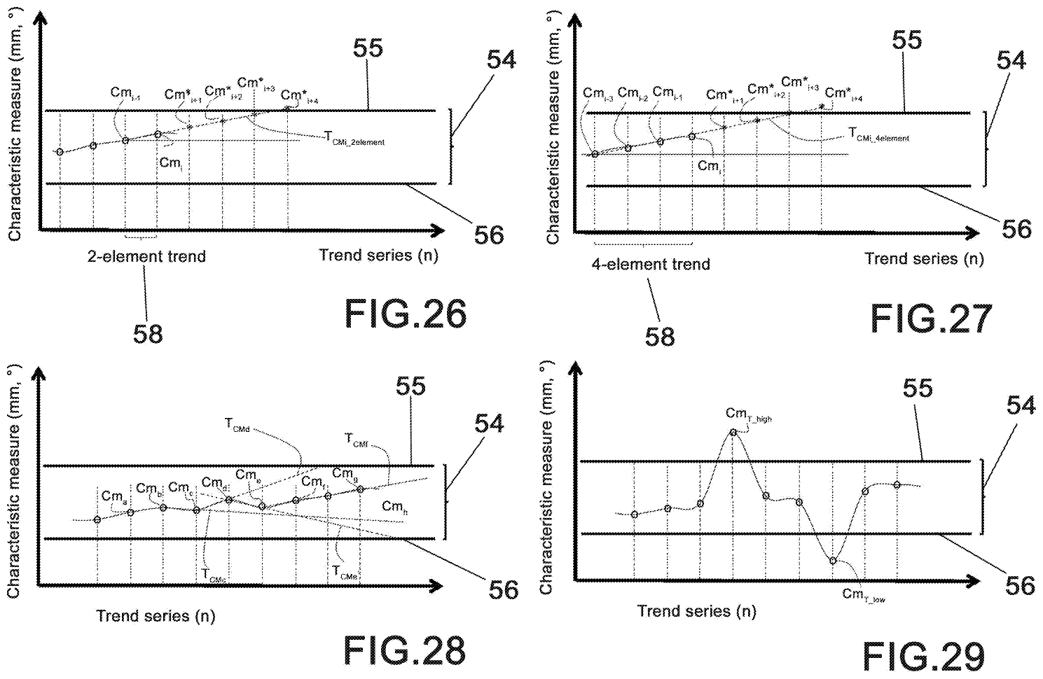

FIGS. 26 and 27 show a trend of a series of values of a characteristic measure and the relevant predicted trend of future values of said characteristic measure in order to determine whether the trend is straying outwards from the tolerance window;

FIG. 28 shows a plurality of evaluated trends of future values of a characteristic measure;

FIG. 29 shows a series of values of a characteristic measure in which some values lie outside the tolerance window.

With reference to FIG. 1, the system for controlling a machine for forming conductor elements or hairpins 17 of an inductive winding of a stator according to the present invention, generally designated by the reference numeral 10, substantially comprises a three-dimensional (3D) vision device 18 and a monitoring device 20. The 3D vision device 18 is associated or associable with a forming machine 12. The monitoring device 20 is operatively connected to the 3D vision device 18, and vice versa. The monitoring device 20 is operatively connected or connectable to the forming machine 12, and vice versa.

The forming machine 12 comprises an electronic control unit 14, preferably of the type of a Programmable Logic Controller (PLC), and forming means 16.

The electronic control unit 14 of the forming machine 12 is operatively connected to the forming means 16, and has suitable capacity for processing and for interfacing with the forming means 16 and with the monitoring device 20.

The electronic control unit 14 of the forming machine 12 is configured to command, control and coordinate the operation of the forming means 16, according to the forming instructions which, as mentioned, comprise parameters that make it possible to obtain conductor elements or hairpins 17 that have the necessary structural characteristics for the use for which they are intended.

The forming means 16 of the forming machine 12 are operatively connected to the electronic control unit 14, and comprise a plurality of electromechanical tools which are configured to perform the operations of bending, calendering, advancement and cutting of the electric wire, for the purpose of producing the conductor elements or hairpins 17.

As mentioned, the operation of the forming means 16 of the forming machine 12 is commanded, controlled and coordinated by the electronic control unit 14, according to the forming instructions.

The 3D vision device 18 of the system 10 according to the invention, which as mentioned is associated or associable with the forming machine 12, is configured to generate a three-dimensional (3D) reconstruction 19 of each conductor element or hairpin 17 produced by, and therefore in output from, the forming machine 12.

The monitoring device 20 of the system 10 according to the invention comprises an electronic control unit 22. The electronic control unit 22 is the main functional element of the monitoring device 20, and for this reason it is operatively connected with the other elements comprised in the monitoring device 20.

The electronic control unit 22 of the monitoring device 20 is provided with suitable capacity for processing and for interfacing with the other elements of the monitoring device 20, and it is configured to command, control and coordinate the operation of the elements of the monitoring device 20 with which it is operatively connected.

The monitoring device 20 of the system 10 according to the invention further comprises a measurement analysis module 24 which is configured to assess at least one characteristic measure 60 of a sequence or series of conductor elements or hairpins 17 produced by, and therefore in output from, the forming machine 12, where this at least one characteristic measure 60 is obtained from each 3D reconstruction 19 of each conductor element 17 produced.

With reference to FIGS. 23 to 29, the measurement analysis module 24 is configured to assess whether a trend 58 of the at least one characteristic measure 60 of a sequence or series of conductor elements or hairpins 17 strays outwards from a tolerance window 54, which is predefined with respect to a corresponding master or reference characteristic measure 62, within a time that is functionally established beforehand, i.e. within a preset number of forming cycles after the most recent conductor element or hairpin 17 produced. The tolerance window 54 described above is constituted by an upper tolerance threshold 55 and a lower tolerance threshold 56.

The term “trend” means a predefined plurality of consecutive elements of a series, at least two. In this case, each element of the series is the at least one characteristic measure 60 of each conductor element or hairpin 17 produced by the forming machine 12. Preferably, the predefined plurality of consecutive elements of the series is constituted by a number of elements comprised between three and ten.

In particular, if the subsequent values of the elements of the series follow a numeric progression such that the value of each element of the series is always greater than or equal to, or less than or equal to, the value of the preceding element in the series, then that numeric series follows a trend 58 of the monotonous type. The monotonous trend 58 of a characteristic measure 60 can indicate a drift straying outwards from the tolerance window 54, while a non-monotonous trend 58 around the value can indicate that the characteristic measure 60 measured is stable with respect to the master or reference characteristic measure 62.

The expression “master or reference characteristic measure” means a value set in the electronic control unit 14 of the forming machine 12 according to the type of conductor element or hairpin 17 to be produced, as said, by means of bending, calendering, advancement and cutting operations.

The set of master or reference characteristic measures 62 defines an ideal master conductor element, i.e. a geometric representation, for example of the Computer-Aided Design/Computer-Aided Manufacturing (CAD/CAM) type, of the conductor element 17 to be produced by the forming machine 12 with the forming means 16. In turn, for each master or reference characteristic measure 62, the predefined tolerance window 54 is defined as the range around the at least one master or reference characteristic measure 62 for which the dimensional values are acceptable in order to ensure the quality of the conductor element 17 produced.

As mentioned, the tolerance window 54 of each master or reference characteristic measure 62 has an upper threshold value 55, defined as the maximum acceptable value for each characteristic measure 60 obtained from the 3D reconstruction 19 of each conductor element or hairpin 17 that is greater than the respective master or reference characteristic measure 62, and a lower threshold value 56, defined as the minimum acceptable value for each characteristic measure 60 obtained from the 3D reconstruction 19 of each conductor element or hairpin 17 that is less than the respective master or reference characteristic measure 62. Advantageously, the upper and lower threshold values 55 and 56 can be set and modified by the human operators in charge of the forming machine 12.

The monitoring device 20 of the system 10 according to the invention further comprises a parameter correction module 26, which is configured to automatically correct one or more parameters of forming instructions, so as to recalibrate the forming machine 12, on the basis of the result of the assessment made previously by the measurement analysis module 24.

Preferably, the parameter correction module 26 is further configured to correct the parameters of forming instructions when the trend 58 assessed by the measurement analysis module 24 strays outwards from a tolerance window 54, predefined with respect to a respective master or reference characteristic measure 62, within a time that is functionally established beforehand, so as to prevent the trend 58 from exiting the tolerance window 54.

In a preferred embodiment, the measurement analysis module 24 is configured to assess whether the trend 58 of the at least one characteristic measure 60 of the sequence or series of conductor elements or hairpins 17 strays outwards from the respective tolerance window 54 by drawing on calculation algorithms, in particular analysis techniques that take account of the trend 58 of the previous values, whereby a subset of values of a series, in particular the most recently available value and the immediately preceding values, the subset being constituted by a predefined number of elements, at least two, preferably at least three, is used to extrapolate a prediction of future values after the values available from the series of values of the at least one characteristic measure 60.

In an embodiment, the measurement analysis module 24 compares the values of the trend 58 of at least one characteristic measure 60 obtained from the 3D reconstruction 19 of each conductor element 17 with the relevant at least one master or reference characteristic measure 62, and any difference between these values represents an error. If the value of the characteristic measure 60 obtained from the 3D reconstruction 19 of each conductor element 17 is higher than the value of the master or reference characteristic measure 62, then it is an error of excess, and conversely if the value of the characteristic measure 60 obtained from the 3D reconstruction 19 of each conductor element 17 is less than the value of the master or reference characteristic measure 62, then it is an error of insufficiency.

If the prediction of subsequent values of the series of values of the at least one characteristic measure 60, i.e. the predicted trend, is outside the tolerance window 54 within a predefined number of predicted cycles, then this prediction indicates a condition of instability to be remedied by means of a correction of the parameters in the instructions of the forming machine 12.

In alternative embodiments, the system 10 according to the invention may adopt techniques of assessing the trend 58 that are different from the technique described above. One of the various alternative techniques that can be applied is the possibility of implementing a linear regression of the trend 58 of the at least one characteristic measure 60 of the sequence or series of conductor elements or hairpins 17 in order to extrapolate predicted future values of the at least one characteristic measure 60 on the basis of the plurality of past values of the trend 58.

Advantageously, if the trend 58 of the at least one characteristic measure 60 strays outwards from the predefined tolerance window 54 within a time that is functionally established beforehand, i.e. within a preset number of forming cycles after the most recent conductor element or hairpin 17 produced, then the measurement analysis module 24 of the monitoring device 20 is further configured to assess the speed at which the trend of the at least one characteristic measure 60 of the sequence or series of conductor elements or hairpins 17 strays outwards from the predefined tolerance window 54 with respect to the corresponding master or reference characteristic measure 62.

Typically, in control systems, the speed at which a signal varies in a series is an indicator used to assess very fast exogenous phenomena of a transitory nature that could result in sharp instabilities capable of suddenly making the system stray outwards from a tolerance window.

Preferably, the measurement analysis module 24 predicts the subsequent values of the at least one characteristic measure 60 by applying an analysis strategy that takes account of the speed with which a monotonous trend of at least one characteristic measure 60 evolves. In other words, if the speed with which the monotonous trend of the at least one characteristic measure 60 varies exceeds a certain threshold, then such speed would indicate that the forming machine 12 is rapidly drifting outwards from the tolerance window 54, and it is therefore necessary to correct the parameters of the forming instructions. This strategy is particularly effective if action is taken promptly, in order to prevent the trend of the at least one characteristic measure 60 from exiting the tolerance window 54.

Advantageously, the measurement analysis module 24 of the monitoring device 20 is further configured to assess at least one characteristic measure 60 of each conductor element or hairpin 17 produced by, and therefore in output from, the forming machine 12. In particular, the measurement analysis module 24 is configured to assess whether the at least one characteristic measure 60 of the conductor element or hairpin 17 lies outside the predefined tolerance window 54 with respect to the corresponding master or reference characteristic measure 62.

If this at least one characteristic measure 60 lies outside the tolerance window 54, then the parameter correction module 26 is further configured to correct the one or more parameters of the forming instructions executed by the forming machine 12 on the basis of a measurable deviation between the at least one characteristic measure 60 obtained from the 3D reconstruction 19 of each conductor element 17 and the master or reference characteristic measure 62, so as to lie once again between the acceptable values defined by the tolerance window 54 of the at least one characteristic measure 60.

The at least one characteristic measure 60 of the conductor element or hairpin 17 is obtained from the 3D reconstruction 19 of the conductor element or hairpin 17, which was generated by the 3D vision device 18. The at least one characteristic measure 60 of the conductor element or hairpin 17 can comprise distances, but also geometric elements like straight segments and/or circular arcs of a reference system, distances from predefined reference planes, points on a reference system, angles with reference directions and/or planes, etc.

In an embodiment, the monitoring device 20 further comprises a measurement extraction module 30 which is configured to obtain the at least one characteristic measure 60 of the conductor element or hairpin 17 from the 3D reconstruction 19 of the conductor element or hairpin 17. In this embodiment, the 3D vision device 18 is further configured to send the 3D reconstruction 19 of the conductor element or hairpin 17 to the monitoring device 20.

In another embodiment, the 3D vision device 18 is further configured to obtain the at least one characteristic measure 60 of the conductor element or hairpin 17 from the 3D reconstruction 19 of the conductor element or hairpin 17. In this embodiment, the 3D vision device 18 is further configured to send the at least one characteristic measure 60 of the conductor element or hairpin 17 to the monitoring device 20.

With reference to FIGS. 18 and 19, in a preferred embodiment, the 3D vision device 18 is configured and arranged so as to acquire an image of each conductor element or hairpin 17 following the operations to form the conductor element or hairpin 17, such forming operations comprising at least bending and cutting the conductor element or hairpin 17. In particular, the 3D vision device 18 acquires the image of each conductor element or hairpin 17 produced after operations to bend, calender, advance and cut each conductor element or hairpin 17 produced. Preferably, the 3D vision device 18 is configured to generate the 3D reconstruction 19 of each conductor element 17 produced by the forming machine 12 starting from, and therefore on the basis of, the image of the conductor element or hairpin 17.

Still with reference to FIGS. 18 and 19, in a preferred embodiment, the system 10 according to the invention further comprises a gripping element 36, which is configured to stably grip the conductor element or hairpin 17 and is arranged to move the conductor element or hairpin 17 produced by the forming machine 12 away along a straight line. The gripping element 36 can be of the robotic gripper type or the like, which can be actuated from a passive position, in which the fingers of the gripper are open, to an active position, in which the fingers of the gripper are closed so as to stably grip the conductor element or hairpin 17.

Preferably, the system 10 according to the invention further comprises a linear movement device 38, and the gripping element 36 is mounted on this linear movement device 38, configured to alternately move away from and approach the forming machine 12 according to a rule of motion controlled using feedback from the operation of the forming machine 12.

Preferably, the gripping element 36 is configured and dimensioned to stably grip the conductor element or hairpin 17 after it has been shaped (the bending, calendering and advancement operations are completed) and before it is cut.

Preferably, the gripping element 36 is further configured to enable the acquisition of the image of each conductor element or hairpin 17 produced by the 3D vision device 18, after the conductor element or hairpin 17 has been cut and when it is being moved away from the forming machine 12.

Preferably, the gripping element 36 is further configured to allow the conditional release of the conductor element or hairpin 17 produced, after the acquisition of the image has been completed, this release being carried out at a location away from the forming machine 12, before the gripping element 36 returns to the starting point in order to grip the next conductor element or hairpin 17 to be cut and measured.

Preferably, the gripping element 36, and as a consequence every conductor element or hairpin 17 produced that is stably gripped by the gripping element 36, is configured to subsequently move away from the forming machine 12 in a direction of removal 32 that is substantially horizontal, or substantially parallel to the advancement direction of the electric wire from which the conductor elements or hairpins 17 are produced.

With reference to FIGS. 20, 21A, 21B and 21C, in a preferred embodiment, the 3D vision device 18 is further configured to consecutively acquire a plurality of partial images 52 of each conductor element or hairpin 17 produced by, and therefore in output from, the forming machine 12. These partial images 52 are subsequently used to generate the 3D reconstruction 19 of each conductor element 17 produced by the forming machine 12.

Preferably, the partial images 52 of the conductor elements or hairpins 17 are dimensioned to be concatenated or combined in order to generate a total or complete image of those conductor elements or hairpins 17. This total or complete image is subsequently used to generate the 3D reconstruction 19 of each conductor element 17 produced by the forming machine 12.

Preferably, the 3D vision device 18 comprises a profilometer. Advantageously, the 3D vision device 18 can use a laser triangulation technique, comprising a laser beam 34 under which the conductor element or hairpin 17 produced by, and therefore in output from, the forming machine 12 slides. Alternatively, the 3D vision device 18 can use other measuring techniques, for example Time-of-Flight or Phase Shift.

Advantageously, the 3D vision device 18 is configured to acquire said partial images 52 when the laser beam 34 strikes the conductor element or hairpin 17 while the conductor element 17 is being moved away from the forming machine 12.

Preferably, the 3D vision device 18 is fixed with respect to the forming machine 12. Preferably, the gripping element 36 and the linear movement device 38 are configured to move each conductor element 17 during the acquisition of the respective partial image 52 and total image used to generate the 3D reconstruction 19. Preferably, the movement of each conductor element 17 is linear during the scanning of the conductor element 17. Preferably, the movement direction of each conductor element 17 is contained in a plane containing at least one of the legs of the conductor element or hairpin 17 and perpendicular to the direction of the laser beam 34 of the 3D vision device 18.

With reference to FIGS. 22A and 22B, in a preferred embodiment, the 3D vision device 18, using the laser triangulation technique (alternatively other measuring techniques, for example Time-of-Flight or Phase Shift, can be used), obtains a point cloud 53 with the distances obtained by the 3D vision device 18. This point cloud 53 is obtained from a concatenation of partial images 52 of the conductor element or hairpin 17. This point cloud 53 is used to generate the total or complete image used in the 3D reconstruction 19.

Preferably, the laser beam 34 emitted by the 3D vision device 18 is oriented substantially perpendicular with respect to the conductor element or hairpin 17 produced by, and therefore in output from, the forming machine 12.

In particular, the end segments AC and BD, which approximate the legs of the conductor element or hairpin 17 produced by, and therefore in output from, the forming machine 12, constitute a plane of removal. Since the direction of removal 32 is parallel to at least one of the end segments AC, BC of the conductor element or hairpin 17, the direction of removal 32 is comprised in the plane of removal.

Preferably, the laser beam 34 emitted by the 3D vision device 18 is oriented substantially perpendicular with respect to the plane of removal, this orientation enabling the 3D vision device 18 to optimize the precision of the geometric characteristics of the partial image 52 and total image acquired, in particular the characteristic points that represent the shape of each conductor element or hairpin 17 produced and which are acquired using the 3D vision device 18.

In an embodiment, the at least one characteristic measure 60 of the conductor element or hairpin 17 uses a global reference system CS_GLOBAL (or CSG), which is integral with the position of the 3D vision device 18. The definition of the global reference system CS_GLOBAL is arbitrary. The position and orientation of the global reference system CS_GLOBAL must be kept as constant as possible over time.

In an embodiment, the at least one characteristic measure 60 of the conductor element or hairpin 17 uses a hairpin reference system CS_HAIRPIN (or CSH), which is integral with the hairpin 17. The link or ratio between CS_GLOBAL and CS_HAIRPIN must remain known for each measurement. Advantageously, each measurement listed below is expressed with respect to the hairpin reference system CS_HAIRPIN, so as to make the dimensions of the hairpin 17 independent of the position of the 3D vision device 18.

In general terms, the system 10 according to the invention can avail of as many reference systems as necessary to optimize the obtaining of the at least one characteristic measure 60 of the conductor element or hairpin 17.

Below is an example list of some types of characteristic measures 60 that can be obtained by the system 10 according to the invention.

In an embodiment, the at least one characteristic measure 60 of the conductor element or hairpin 17 comprises a segment AC, i.e. a three-dimensional (3D) segment that best approximates the first leg of the hairpin 17 (with reference to the characteristic points, this is the segment AC of the hairpin 17).

In an embodiment, the at least one characteristic measure 60 of the conductor element or hairpin 17 comprises a segment BD, i.e. a three-dimensional (3D) segment that best approximates the second leg of the hairpin 17 (with reference to the characteristic points, this is the segment BD of the hairpin 17).

In an embodiment, the at least one characteristic measure 60 of the conductor element or hairpin 17 comprises a segment CE, i.e. a three-dimensional (3D) segment that best approximates the first calendering arc of the hairpin 17 (with reference to the characteristic points, this is the segment CE of the hairpin 17).

In an embodiment, the at least one characteristic measure 60 of the conductor element or hairpin 17 comprises a segment DE, i.e. a three-dimensional (3D) segment that best approximates the second calendering arc of the hairpin 17 (with reference to the characteristic points, this is the segment DE of the hairpin 17).

The concatenation of the segments CE and DE constitutes the segment CD, this segment CD being the segment that best approximates the calendered portion of the conductor element or hairpin 17.

In an embodiment, the at least one characteristic measure 60 of the conductor element or hairpin 17 comprises the characteristic point C, or first bending point C, i.e. the three-dimensional (3D) point of intersection between the segment AC and the segment CE.

In an embodiment, the at least one characteristic measure 60 of the conductor element or hairpin 17 comprises the characteristic point D, or second bending point D, i.e. the three-dimensional (3D) point of intersection between the segment BD and the segment DE.

In an embodiment, the at least one characteristic measure 60 of the conductor element or hairpin 17 comprises a headwidth, HeadWidth, i.e. the Euclidean distance between the point C and the point D of the head of the hairpin 17.

In an embodiment, the at least one characteristic measure 60 of the conductor element or hairpin 17 comprises a virtual resting plane Pₐᵥ, i.e. a virtual resting plane of the hairpin 17 on the segments AC and BD. In other words, the virtual resting plane Pₐᵥ is defined as the plane that results from laying the hairpin 17 on a horizontal surface with the point E of the segment CD directed downward with respect to the horizontal surface, the segment AC being laid on the horizontal surface, the virtual resting plane Pₐᵥ comprising the segment AC and the point D of the hairpin 17.

With reference to FIGS. 4 and 5, in an embodiment, the at least one characteristic measure 60 of the conductor element or hairpin 17 comprises a first twisting plane Pₜ₁, i.e. a plane that best approximates the upper surface of the first leg of the hairpin 17 (with reference to the characteristic points, this is the segment AC of the hairpin 17), when this first leg is subjected to a twisting action, considering the conductor element or hairpin 17 with the curvature directed upward, i.e. when the point E is lower with respect to the substantially horizontal first leg.

Still with reference to FIGS. 4 and 5, in an embodiment, the at least one characteristic measure 60 of the conductor element or hairpin 17 comprises a first perpendicular plane Pₙ₁, i.e. a plane that is perpendicular to the first twisting plane Pₜ₁ and which coincides with the external surface of the first leg of the hairpin 17 (with reference to the characteristic points, this is the segment AC of the hairpin 17).

With reference to FIGS. 6 and 7, in an embodiment, the at least one characteristic measure 60 of the conductor element or hairpin 17 comprises a central bending profile S_{XYZ}, i.e. a list of N points, N being a number predefined by the system, these N points being expressed with respect to the hairpin reference system CS_HAIRPIN and representing the S-shaped central bend of the hairpin 17. Note that this S-shape can be represented by the following sequence: segment 1+arc of circumference 1+arc of circumference 2+segment 2.

Once the first perpendicular plane Pₙ₁ is identified, it is possible to identify two planes Pd₁ and Pd_{N} that are parallel to the first perpendicular plane Pₙ₁, these two planes Pd₁ and Pd_{N} intersecting the hairpin 17 at the ends of the S-shaped central bend of the hairpin 17. The position of these two planes Pd₁ and Pd_{N} with respect to a reference system is given by respective distances d₁ and d_{N}, these two distances d₁ and d_{N} representing the respective distances of the ends of the S-shaped central bend of the hairpin 17 from the first perpendicular plane Pₙ₁. The portion of hairpin 17 defined by the planes Pd₁ and Pd_{N} is furthermore cross-sectioned into N−2 more equidistant planes, N−2 being a number predefined by the system. One of these planes is shown in FIGS. 6 and 7 and is called P_{dk}. Each plane P_{dk} identifies a cross-section of the hairpin 17. The XYZ coordinates with respect to the hairpin reference system CS_HAIRPIN of the point of this cross-section with the maximum coordinate component in the direction of the Y axis of the hairpin reference system corresponds to the point k of the profile S_{XYZ}.

In an embodiment, the at least one characteristic measure 60 of the conductor element or hairpin 17 comprises a first central bending segment S_{seg1}, i.e. a three-dimensional (3D) segment that best approximates the first portion of the central bending profile S_{XYZ}, said first central bending segment S_{seg1} being delimited in one of the two ends of said segment in the neighborhood of the point E.

In an embodiment, the at least one characteristic measure 60 of the conductor element or hairpin 17 comprises a first central bending circumference S_{cir1}, i.e. a circumference that best approximates the first curve of the central bending profile S_{XYZ}.

In an embodiment, the at least one characteristic measure 60 of the conductor element or hairpin 17 comprises a second central bending circumference S_{cir2}, i.e. a circumference that best approximates the second curve of the central bending profile S_{XYZ}.

In an embodiment, the at least one characteristic measure 60 of the conductor element or hairpin 17 comprises a second central bending segment S_{seg2}, i.e. a three-dimensional (3D) segment that best approximates the second portion of the central bending profile S_{XYZ}, said second central bending segment S_{seg2} being delimited in one of the two ends of said segment in the neighborhood of the point E.

In an embodiment, the at least one characteristic measure 60 of the conductor element or hairpin 17 comprises a first calendering circumference Circ₁, i.e. a circumference that best approximates the first calendering arc of the hairpin 17 (with reference to the characteristic points, this is the segment CE of the hairpin 17).

With reference to FIG. 8, in an embodiment, the at least one characteristic measure 60 of the conductor element or hairpin 17 comprises a first calendering plane P_{c1}, i.e. a plane that best approximates the arrangement of the first calendering circumference Circ₁ comprising the first calendering arc of the hairpin 17 (with reference to the characteristic points, this is the segment CE of the hairpin 17).

With reference to FIGS. 9 and 10, in an embodiment, the at least one characteristic measure 60 of the conductor element or hairpin 17 comprises a first calendering radius R_{c1} (or CalenderingRadiusCE), i.e. a radial dimension of the first calendering circumference Circ₁ that best approximates the first calendering arc of the hairpin 17 (with reference to the characteristic points, this is the segment CE of the hairpin 17). Once the first perpendicular plane Pₙ₁ is identified, it is possible to identify two planes Sc₁ and Sc₂ that are parallel to the first perpendicular plane Pₙ₁ and which intersect the hairpin 17. The position of these two planes Sc₁ and Sc₂ is given by the respective distances c₁ and c₂. These two planes Sc₁ and Sc₂ define the portion of hairpin 17 on which the circumference is adapted. The approximation is calculated using the points that lie on the flat region (excluding the joins) of the portion of hairpin 17 contained between the intersections of the plane Sc₁ and of the plane Sc₂ with the hairpin 17.

In an embodiment, the at least one characteristic measure 60 of the conductor element or hairpin 17 comprises a second calendering circumference Circ₂, i.e. a circumference that best approximates the second calendering arc of the hairpin 17 (with reference to the characteristic points, this is the segment DE of the hairpin 17).

With reference to FIG. 11, in an embodiment, the at least one characteristic measure 60 of the conductor element or hairpin 17 comprises a second calendering plane P_{c2}, i.e. a plane that best approximates the arrangement of the second calendering circumference Circ₂ comprising the second calendering arc of the hairpin 17 (with reference to the characteristic points, this is the segment DE of the hairpin 17).

Note that the combination of the orientations between the first calendering plane P_{c1} and the second calendering plane P_{c2}, together with the profile S_{XYZ}, defines the geometric characteristics of the central bend of the hairpin 17.

With reference to FIG. 12, in an embodiment, the at least one characteristic measure 60 of the conductor element or hairpin 17 comprises a second calendering radius R_{c2} (or CalenderingRadiusDE), i.e. a radial dimension of the second calendering circumference Circ₂ that best approximates the second calendering arc of the hairpin 17 (with reference to the characteristic points, this is the segment DE of the hairpin 17). Once the second perpendicular plane Pₙ₂ is identified, it is possible to identify two planes Sc₃ and Sc₄ that are parallel to the second perpendicular plane Pₙ₂ and which intersect the hairpin 17. The position of these two planes Sc₃ and Sc₄ is given by the respective distances c₃ and c₄. These two planes Sc₃ and Sc₄ define the portion of hairpin 17 on which the circumference is adapted. The approximation is calculated using the points that lie on the flat region (excluding the joins) of the portion of hairpin 17 contained between the intersections of the plane Sc₃ and of the plane Sc₄ with the hairpin 17.

With reference to FIG. 13, in an embodiment, the at least one characteristic measure 60 of the conductor element or hairpin 17 comprises a second twisting plane Pₜ₂, i.e. a plane that best approximates the upper surface of the second leg of the hairpin 17 (with reference to the characteristic points, this is the segment BD of the hairpin 17), when this second leg is subjected to a twisting action, considering the conductor element or hairpin 17 with the curvature directed upward, i.e. when the point E is lower with respect to the substantially horizontal second leg.

Still with reference to FIG. 13, in an embodiment, the at least one characteristic measure 60 of the conductor element or hairpin 17 comprises a second perpendicular plane Pₙ₂, i.e. a plane that is perpendicular to the second twisting plane Pₜ₂ and which coincides with the external surface of the second leg of the hairpin 17 (with reference to the characteristic points, this is the segment BD of the hairpin 17).

Starting from one or more of the measurements described above, it is possible to indirectly obtain the measurements described below.

With reference to FIG. 14, in an embodiment, the at least one characteristic measure 60 of the conductor element or hairpin 17 comprises the characteristic point C, or first bending point C. With the planes Pₜ₁, P_{c1} and Pₙ₁ known, it is possible to identify the position of the characteristic point C of the hairpin 17. In particular, it is possible to define the point C as the intersection between the planes Pₜ₁, P_{c1}, Pₙ₁.

Still with reference to FIG. 14, in an embodiment, the at least one characteristic measure 60 of the conductor element or hairpin 17 comprises the characteristic point D, or second bending point D. With the planes Pₜ₂, P_{c2} and Pₙ₂ known, it is possible to identify the position of the characteristic point D of the hairpin 17. In particular, it is possible to define the point D as the intersection between the planes Pₜ₂, P_{c2}, Pₙ₂.

With reference to FIG. 15, in an embodiment, the at least one characteristic measure 60 of the conductor element or hairpin 17 comprises an angle between twists αₜ, i.e. the angle between the first twisting plane Pₜ₁ of the first leg of the hairpin 17 and the second twisting plane Pₜ₂ of the second leg of the hairpin 17.

In an embodiment, the at least one characteristic measure 60 of the conductor element or hairpin 17 comprises a first twisting angle αₜ₁, i.e. the angle between the virtual resting plane Pₐᵥ and the first twisting plane Pₜ₁ of the first leg of the hairpin 17.

In an embodiment, the at least one characteristic measure 60 of the conductor element or hairpin 17 comprises a second twisting angle αₜ₂, i.e. the angle between the virtual resting plane Pₐᵥ and the second twisting plane Pₜ₂ of the second leg of the hairpin 17.

In an embodiment, the at least one characteristic measure 60 of the conductor element or hairpin 17 comprises an angle α₀, i.e. the angle between the virtual resting plane Pₐᵥ and the zero plane of the 3D vision device 18.

In an embodiment, the at least one characteristic measure 60 of the conductor element or hairpin 17 comprises a height CSC, i.e. the difference in elevation between the point CSC and the virtual resting plane Pₐᵥ. The point CSC is the point of maximum distance of the central bend from the virtual resting plane Pₐᵥ (with reference to the characteristic points, the point CSC is in the neighborhood of the point E of the hairpin 17).

In an embodiment, the at least one characteristic measure 60 of the conductor element or hairpin 17 comprises a central bending angle βc, i.e. the angle between the first calendering plane P_{c1} and the second calendering plane P_{c2}, i.e. the angle between the segment CE and the segment DE of the hairpin 17.

With reference to FIGS. 16 and 17, in an embodiment, the at least one characteristic measure 60 of the conductor element or hairpin 17 comprises a first bending angle β₁, i.e. the resultant angle between the first perpendicular plane Pₙ₁ and the first calendering plane P_{c1}. Since these two planes Pₙ₁ and P_{c1} can be skewed, we can identify the axis A₀₁, which passes through the planes P_{c1} and Pₜ₁, and the axis A₀₂, which passes through the planes P_{c1} and Pₙ₁. Starting from these axes A₀₁ and A₀₂, we can identify the two angles:
main first bending angle β₁₀, i.e. the resultant angle between the axis A₀₁ and the Z-axis of the hairpin reference system, i.e. the resultant angle between the segment AC and the segment CE of the hairpin 17. Note that this is the main measurement observed by the operator for assessing the good outcome of the first bending; and/or
secondary first bending angle β₁₁, i.e. the resultant angle between the axis A₀₂ and the Y-axis of the hairpin reference system. This angle identifies the twist of the first calendering arc of the hairpin 17.

In an embodiment, the at least one characteristic measure 60 of the conductor element or hairpin 17 comprises a second bending angle β₂, i.e. the resultant angle between the second perpendicular plane Pₙ₂ and the second calendering plane P_{c2}. Since these two planes Pₙ₂ and P_{c2} can be skewed, we can identify the axis A₁₁, which passes through the planes P_{c2} and Pₜ₂, and the axis A₁₂, which passes through the planes P_{c2} and Pₙ₂. Starting from these axes A₁₁ and A₁₂, we can identify the two angles:
main second bending angle β₂₀, i.e. the angle between the axis A₁₁ and the Z-axis of the hairpin reference system, i.e. the angle between the segment BD and the segment DE of the hairpin 17. Note that this is the main measurement observed by the operator for assessing the good outcome of the second bending; and/or
secondary second bending angle β₂₁, i.e. the angle between the axis A₁₂ and the Y-axis of the hairpin reference system. This angle identifies the twist of the second calendering arc of the hairpin 17.

In an embodiment, the at least one characteristic measure 60 of the conductor element or hairpin 17 comprises an angle γₛ, i.e. the angle between the first central bending segment S_{seg1} and the second central bending segment S_{seg2}.

In an embodiment, the at least one characteristic measure 60 of the conductor element or hairpin 17 comprises an angle γₛ₁, i.e. the angle between the first central bending segment S_{seg1} and the straight line that passes through the centers of the first and of the second central bending circumference S_{cir1} and S_{cir2}.

In an embodiment, the at least one characteristic measure 60 of the conductor element or hairpin 17 comprises an angle γₛ₂, i.e. the angle between the second central bending segment S_{seg2} and the straight line that passes through the centers of the first and of the second central bending circumference S_{cir1} and S_{cir2}.

In an embodiment, the at least one characteristic measure 60 of the conductor element or hairpin 17 comprises a first leg trim height δ₁, i.e. the difference in height between the zone closest to the characteristic point C of the segment AC of the hairpin 17 and the zone projected on the characteristic point A of the segment AC of the hairpin 17.

In an embodiment, the at least one characteristic measure 60 of the conductor element or hairpin 17 comprises a second leg trim height δ₂ i.e. the difference in height between the zone closest to the characteristic point D of the segment BD of the hairpin 17 and the zone projected on the characteristic point B of the segment BD of the hairpin 17.

Preferably, the at least one characteristic measure of the conductor element 17 or hairpin is selected from a group constituted by points, straight and/or curved segments, lengths and radii of curvature of bending, calendering and/or twisting of segments of the conductor element, plane angles, three-dimensional angles, coordinates and/or distances with respect to a Cartesian reference system, distances and angles with respect to predefined planes, like those defined previously.

Advantageously, the at least one characteristic measure 60 of the conductor element or hairpin 17 comprises at least one of the elements defined previously: segment AC, segment BD, segment CE, segment DE, segment CD, characteristic point (or bending point) C, characteristic point (or bending point) D, headwidth HeadWidth, virtual resting plane Pₐᵥ, first twisting plane Pₜ₁, first perpendicular plane Pₙ₁, central bending profile S_{XYZ}, first central bending segment S_{seg1}, first central bending circumference S_{cir1}, second central bending circumference S_{cir2}, second central bending segment S_{seg2}, first calendering circumference Circ₁, first calendering plane P_{c1}, first calendering radius R_{c1}, second calendering circumference Circ₂, second calendering plane P_{c2}, second calendering radius R_{c2}, second twisting plane Pₜ₂, second perpendicular plane Pₙ₂, angle between twists αₜ, first twisting angle αₜ₁, second twisting angle αₜ₂, angle α₀, height CSC, central bending angle βc, first bending angle β₁, second bending angle β₂, angle γₛ, angle γₛ₁, angle γₛ₂, first leg trim height δ₁, and second leg trim height δ₂.

Advantageously, the parameter correction module 26 of the monitoring device 20 of the system 10 according to the invention is provided with at least one model based on artificial intelligence (AI), these AI models being configured to automatically correct the parameters of the forming instructions, so as to recalibrate the forming machine 12, on the basis of the outcome of the assessment performed previously by the measurement analysis module 24, i.e. on the basis of the trend of the at least one characteristic measure 60 of the sequence or series of conductor elements or hairpins 17 that has strayed outwards from the respective tolerance window 54, or optionally on the basis of the at least one characteristic measure 60 of the conductor element or hairpin 17 when this at least one characteristic measure 60 of the conductor element 17 lies outside the respective tolerance window 54, i.e. when it is already located outside the respective tolerance window 54. In an embodiment, the parameter correction module 26 of the monitoring device 20 is configured to automatically correct the parameters of the forming instructions on the basis of the difference of the at least one characteristic measure 60 of the conductor element or hairpin 17 obtained from the 3D reconstruction 19 with respect to the corresponding master or reference characteristic measure 62.

Therefore, the parameter correction module 26 of the monitoring device 20 receives in input both the parameters of the forming instructions executed by the forming machine 12, and also the at least one characteristic measure 60 of the conductor element or hairpin 17 obtained from the 3D reconstruction 19 of the conductor element or hairpin 17, for example by the measurement extraction module 30 of the monitoring device 20 or by the 3D vision device 18.

The monitoring device 20, in particular the relevant electronic control unit 22, is configured to send the corrected parameters of the forming instructions to the forming machine 12, in particular to the relevant electronic control unit 14.

Advantageously, the monitoring device 20 of the system 10 according to the invention further comprises a memory unit 28 which is configured to record the parameters, for example current or past, of the forming instructions executed by the forming machine 12. Preferably, the memory unit 28 is further configured to record the at least one characteristic measure 60 of each conductor element or hairpin 17. In an embodiment, the memory unit 28 is further configured to record the master or reference characteristic measure 62 corresponding to the at least one characteristic measure 60 of the conductor element or hairpin 17.

With reference to FIG. 2, the method for controlling a machine for forming conductor elements or hairpins 17 of an inductive winding of a stator according to the present invention comprises the steps described below.

Initially, in step 41, a three-dimensional reconstruction (3D) 19 is generated of each conductor element or hairpin 17 produced by, and therefore in output from, a forming machine 12, using a 3D vision device 18 which is associated or associable with the forming machine 12.

In step 42, at least one characteristic measure 60 of the conductor element or hairpin 17 is obtained from the 3D reconstruction 19 of the conductor element or hairpin 17, which was generated in the previous step 41 by the 3D vision device 18. As said, the at least one characteristic measure 60 of the conductor element or hairpin 17 can comprise distances, but also geometric elements like straight segments and/or circular arcs of a reference system, distances from predefined reference planes, points on a reference system, angles with reference directions and/or planes etc.

In an embodiment, in step 42, the at least one characteristic measure 60 of the conductor element or hairpin 17 is obtained from the 3D reconstruction 19 of the conductor element or hairpin 17, using a measurement extraction module 30 which is comprised in a monitoring device 20. In this embodiment, the 3D vision device 18 sends the 3D reconstruction 19 of the conductor element or hairpin 17 to the monitoring device 20.

In another embodiment, in step 42, the at least one characteristic measure 60 of the conductor element or hairpin 17 is obtained from the 3D reconstruction 19 of the conductor element or hairpin 17, using the 3D vision device 18. In this embodiment, the 3D vision device 18 sends the at least one characteristic measure 60 of the conductor element or hairpin 17 to the monitoring device 20.

In step 43, the at least one characteristic measure 60 of a sequence or series of conductor elements or hairpins 17 produced by, and therefore in output from, the forming machine 12 is assessed, using a measurement analysis module 24 which is comprised in the monitoring device 20. In particular, it is assessed whether a trend of the at least one characteristic measure 60 of the sequence or series of conductor elements or hairpins 17 is straying outwards from a predefined tolerance window 54 with respect to a corresponding master or reference characteristic measure 62.

Advantageously, in step 43, if the trend of the at least one characteristic measure 60 strays outwards from the predefined tolerance window 54, then an assessment is furthermore made of the speed at which the trend of the at least one characteristic measure 60 of the sequence or series of conductor elements or hairpins 17 strays outwards from the predefined tolerance window 54 with respect to the corresponding master or reference characteristic measure 62, using the measurement analysis module 24 of the monitoring device 20.

Advantageously, in step 43, an assessment is furthermore made of at least one characteristic measure 60 of each conductor element or hairpin 17 produced by, and therefore in output from, the forming machine 12, using the measurement analysis module 24 of the monitoring device 20. In particular, it is assessed whether the at least one characteristic measure 60 of the conductor element or hairpin 17 lies outside the predefined tolerance window 54 with respect to a corresponding master or reference characteristic measure 62.

In step 44, the parameters of the forming instructions are corrected automatically, so as to recalibrate the forming machine 12, on the basis of the trend of the at least one characteristic measure 60 of the sequence or series of conductor elements or hairpins 17 that is straying outwards from the predefined tolerance window 54 within a time that is functionally established beforehand, or optionally on the basis of the at least one characteristic measure 60 of the conductor element or hairpin 17 when this at least one characteristic measure 60 of the conductor element 17 lies outside the respective tolerance window 54, i.e. when it is already located outside the respective tolerance window 54, using a parameter correction module 26. Advantageously, the step 44 of automatically correcting the parameters of the forming instructions draws on a model based on artificial intelligence (AI) which is comprised in the parameter correction module 26 of the monitoring device 20. Also in step 44, the monitoring device 20 sends the corrected parameters of the forming instructions to the forming machine 12.

In an embodiment, the parameters of the forming instructions are automatically corrected on the basis of the difference of the at least one characteristic measure 60 of the conductor element or hairpin 17 with respect to the corresponding master or reference characteristic measure 62.

In practice it has been found that the present invention fully achieves the set aim and objects. In particular, it has been seen that the system and the method for controlling a machine for forming conductor elements or hairpins of an inductive winding of a stator, thus conceived, make it possible to overcome the qualitative limitations of the known art, in that they make it possible to obtain better effects than those that can be obtained with conventional solutions and/or similar effects at lower cost and with higher performance levels.

An advantage of the system and of the method for controlling a machine for forming conductor elements or hairpins of an inductive winding of a stator according to the present invention consists in that they make it possible to adapt the operation of the forming machine, i.e. the operations performed by the forming machine, to the external interference conditions, such as for example variations in the hardness of the material used and variations in the ambient temperature.

Another advantage of the system and of the method for controlling a machine for forming conductor elements or hairpins of an inductive winding of a stator according to the present invention consists in that they make it possible to adapt the operation of the forming machine, i.e. the operations performed by the forming machine, to the working conditions, such as for example the play inside the forming machine, and variations in friction inside the forming machine.

Another advantage of the system and of the method for controlling a machine for forming conductor elements or hairpins of an inductive winding of a stator according to the present invention consists in that they make it possible to make the forming process, in particular the operations performed by the forming machine, independent of the capabilities and/or conditions of human operators, so passing from a subjective checking to an objective and standardized checking, which leads to predictable and repeatable results.

Another advantage of the system and of the method for controlling a machine for forming conductor elements or hairpins of an inductive winding of a stator according to the present invention consists in that they make it possible to eliminate, or at least minimize, the reaction times after the first hairpin produced with characteristic measures outside the tolerance window.

Another advantage of the system and of the method for controlling a machine for forming conductor elements or hairpins of an inductive winding of a stator according to the present invention consists in that they make it possible to confer greater stability to the forming process, in particular to the operations performed by the forming machine.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

In conclusion, the scope of protection of the claims shall not be limited by the explanations or by the preferred embodiments illustrated in the description by way of examples, but rather the claims shall comprise all the patentable characteristics of novelty that reside in the present invention, including all the characteristics that would be considered as equivalent by the person skilled in the art.

The disclosures in Italian Patent Application No. 102022000008915 from which this application claims priority are incorporated herein by reference.

Where the technical features mentioned in any claim are followed by reference numerals and/or signs, those reference numerals and/or signs have been included for the sole purpose of increasing the intelligibility of the claims and accordingly, such reference numerals and/or signs do not have any limiting effect on the interpretation of each element identified by way of example by such reference numerals and/or signs.

1-20. (canceled)

21. A system for controlling a machine for forming conductor elements of an inductive winding of a stator, comprising:
a 3D vision device which is configured to generate a 3D reconstruction of each conductor element produced by said forming machine; and
a monitoring device which is operatively connected to said 3D vision device and operatively connectable to said forming machine;
wherein said monitoring device comprises:
a measurement analysis module which is configured to assess at least one monitored characteristic measure of conductor elements that are produced by said forming machine; and
a parameter correction module which is configured to correct one or more parameters of forming instructions that are executed by said forming machine;
wherein
said measurement analysis module of said monitoring device is further configured to assess a trend of said at least one characteristic measure of a sequence of said conductor elements produced by said forming machine, said at least one monitored characteristic measure being obtained from said 3D reconstruction of said conductor element, and
said parameter correction module of said monitoring device is further configured to correct said parameters of forming instructions when said trend assessed by said measurement analysis module strays outwards from a tolerance window defined with respect to a respective reference characteristic measure, so as to prevent said trend from exiting said tolerance window.

22. The system according to claim 21, wherein said measurement analysis module of said monitoring device is further configured to assess a speed at which said trend of said at least one characteristic measure of said sequence of conductor elements produced by said forming machine strays outwards from said predefined tolerance window.

23. The system according to claim 21, wherein said measurement analysis module of said monitoring device is further configured to assess whether each one of said at least one characteristic measure of said conductor element produced by said forming machine lies outside said predefined tolerance window, and wherein said parameter correction module of said monitoring device is further configured to correct said parameters of forming instructions that are executed by said forming machine on the basis of a measurable deviation between said at least one characteristic measure of said conductor element and said reference characteristic measure.

24. The system according to claim 21, wherein said monitoring device further comprises a measurement extraction module which is configured to extract said at least one characteristic measure of said conductor element from said 3D reconstruction of said conductor element, said 3D vision device being further configured to send said 3D reconstruction of said conductor element to said monitoring device.

25. The system according to claim 21, wherein said 3D vision device is further configured to extract said at least one characteristic measure of said conductor element from said 3D reconstruction of said conductor element, said 3D vision device being further configured to send said at least one characteristic measure of said conductor element to said monitoring device.

26. The system according to claim 21, wherein said 3D vision device is configured and arranged so as to optically acquire at least one image of each conductor element following the bending and cutting operations executed by said forming machine.

27. The system according to claim 21, wherein said at least one characteristic measure of said conductor element is selected from a group constituted by lengths and radii of curvature of bending, calendering and/or twisting of segments of said conductor element, plane angles, three-dimensional angles, coordinates and/or distances with respect to a Cartesian reference system, distances and angles with respect to predefined planes.

28. The system according to claim 21, further comprising a gripping element which is configured to move said conductor element produced by said forming machine away along a straight line in a direction of removal which is substantially parallel to an advancement direction of the electric wire from which said conductor elements are produced.

29. The system according to claim 21, wherein said 3D vision device is further configured to consecutively acquire a plurality of partial images of said conductor element produced by said forming machine, in order to generate said 3D reconstruction of said conductor element produced by said forming machine.

30. The system according to claim 29, wherein said 3D vision device is further configured to acquire each one of said partial images with a profilometer, said profilometer being configured to emit a laser beam oriented substantially perpendicular with respect to a plane of removal defined by two segments which approximate the legs of said conductor element produced in the shape of a hairpin.

31. The system according to claim 21, wherein said parameter correction module comprises at least one artificial intelligence model which is configured to automatically correct said parameters of forming instructions.

32. A method for controlling a machine for forming conductor elements of an inductive winding of a stator, using a 3D vision device and a monitoring device, said 3D vision device being associable with said forming machine, said monitoring device being operatively connected to said 3D vision device and operatively connectable to said forming machine, which comprises the steps of:
generating a 3D reconstruction of each conductor element produced by said forming machine, using said 3D vision device;
extracting at least one characteristic measure of said conductor element from said 3D reconstruction of said conductor element produced by said forming machine;
assessing said at least one characteristic measure of conductor elements produced by said forming machine, using a measurement analysis module which is comprised within said monitoring device; and
correcting one or more parameters of forming instructions executed by said forming machine, using a parameter correction module which is comprised within said monitoring device;
wherein
said step of assessing further comprises the assessment of a trend of said at least one characteristic measure of a sequence of said conductor elements produced by said forming machine, and
said step of correcting said parameters of forming instructions occurs when said trend strays outwards from a tolerance window defined with respect to a respective reference characteristic measure, so as to prevent said trend from exiting said tolerance window.

33. The method according to claim 32, wherein said step of assessing further comprises the assessment of a speed at which said trend of said at least one characteristic measure of said sequence of conductor elements produced by said forming machine strays outwards from said predefined tolerance window.

34. The method according to claim 32, wherein said step of assessing further comprises the assessment of whether each one of said at least one characteristic measure of said conductor element produced by said forming machine lies outside said predefined tolerance window with respect to said reference characteristic measure, and said step of correcting further comprises the correction of said parameters of forming instructions that are executed by said forming machine on the basis of a measurable deviation between said at least one characteristic measure of said conductor element and said reference characteristic measure.

35. The method according to claim 32, further comprising, before the step of generating said 3D reconstruction, a step of optically acquiring at least one image of each conductor element following the bending and cutting operations executed by said forming machine, using said 3D vision device.

36. The method according to claim 32, wherein said at least one characteristic measure of the conductor element is selected from a group constituted by lengths and radii of curvature of bending, calendering and/or twisting of segments of said conductor element, plane angles, three-dimensional angles, coordinates and/or distances with respect to a Cartesian reference system, distances with respect to predefined planes.

37. The method according to claim 35, wherein, in said step of optically acquiring at least one image of each conductor element, said conductor element produced is moved by said forming machine away along a straight line in a direction of removal which is substantially parallel to an advancement direction of the electric wire from which said conductor elements are produced.

38. The method according to claim 35, wherein said step of optically acquiring said image of each conductor element further comprises a consecutive acquisition of a plurality of partial images of said conductor element produced by said forming machine, in order to generate said 3D reconstruction of said conductor element produced by said forming machine.

39. The method according to claim 38, wherein said step of optically acquiring each one of said partial images is performed with a profilometer, said profilometer being configured to emit a laser beam oriented substantially perpendicular with respect to a plane of removal defined by two segments (AC, BD) which approximate the legs of said conductor element produced in the shape of a hairpin.

40. The method according to claim 32, wherein, in said step of correcting said parameters of forming instructions, said parameter correction module draws on at least one artificial intelligence model which is configured to automatically correct said parameters of forming instructions.
